(19) United States
(12) Patent Application Publication
(10) Pub. No.: US 2026/0327814 A1
(43) Pub. Date: Oct. 22, 2026

(54) ELECTROCHEMICAL SYNTHESIS OF HYDROGEN PEROXIDE USING POROUS CARBON MATERIALS CONTAINING BORON FROM CARBON OXIDE-CONTAINING GAS

(71) Applicants: KOREA ADVANCED INSTITUTE OF SCIENCE AND TECHNOLOGY, Daejeon (KR); KOREA INSTITUTE OF SCIENCE AND TECHNOLOGY, Seoul (KR)

(72) Inventors: Jae W LEE, Daejeon (KR); Ayeong BYEON, Daejeon (KR); Won Chan YUN, Daejeon (KR); Jong Min KIM, Seoul (KR); Jae Won CHOI, Seoul (KR); Chang Kyu HWANG, Seoul (KR); Sae Yane PAEK, Seoul (KR)

(21) Appl. No.: 19/107,553

(22) PCT Filed: Oct. 17, 2023
(86) PCT No.: PCT/KR2023/016000

§ 371 Date: Feb. 27, 2025

(30) Foreign Application Priority Data
Oct. 18, 2022 (KR) 10-2022-0133934

(51) Int. Cl. C25B 1/30; C25B 11/031; C25B 11/065

(52) U.S. Cl. CPC C25B 1/30; C25B 11/031; C25B 11/065

(57) ABSTRACT

Disclosed is a method wherein a boron-doped hierarchical porous carbon material is produced by allowing carbon dioxide-containing flue gas or production process waste gas to react with a reducing agent or a mixture of a reducing agent and nanotemplates at high temperature and is used as a catalyst for electrochemical production of hydrogen peroxide. The boron-containing hierarchical porous carbon material produced herein is environmentally friendly because it is synthesized from carbon dioxide under relatively mild conditions (normal pressure), and may be used as a catalyst for two-electron oxygen reduction reaction for the electrochemical production of hydrogen peroxide due to the hierarchical presence of micropores and mesopores and the doped heteroatom boron.

### TECHNICAL FIELD

The present invention relates to a method for electrochemical production of hydrogen peroxide using a boron-containing porous carbon material produced from a carbon dioxide-containing gas, and more particularly, to a method for electrochemical production of hydrogen peroxide using a boron-containing porous carbon material produced from a carbon dioxide-containing gas, wherein a boron-doped hierarchical porous carbon material is produced by allowing carbon dioxide-containing flue gas or production process waste gas to react with a reducing agent or a mixture of a reducing agent and nanotemplates at high temperature and is used as a catalyst for electrochemical production of hydrogen peroxide.

### BACKGROUND ART

Hydrogen peroxide is one of chemicals that are widely used in various fields, such as pulp bleaching, wastewater treatment, semiconductor manufacture, and medicine. The anthraquinone process is currently being used as a method to synthesize hydrogen peroxide in large amounts. However, this method has shortcomings in that organic materials are difficult to recycle, a large amount of energy is required during synthesis, an expensive palladium catalyst is used, and only mass production is possible and thus transportation of hydrogen peroxide is difficult due to the explosive nature thereof. As an alternative to this method, a method of electrochemically producing hydrogen peroxide has been proposed. This method has advantages in that it is environmentally friendly because it does not emit by-products such as non-recyclable organic materials, and in that it can produce hydrogen peroxide on-site in real time, and hydrogen peroxide, which is explosive, can be produced and used in situ without having to be transported directly.

In order to electrochemically generate hydrogen peroxide as described above, it is required to carry out two-electron oxygen reduction reaction (ORR) in a fuel cell. The reaction formula for the two-electron oxygen reduction reaction is as follows:

O₂+2(H⁺+e⁻)→*OOH+(H⁺+e⁻)→H₂O₂

In the oxygen reduction reaction, materials such as Pd, Au, and Pt—Hg are used as catalysts for the two-electron oxygen reduction reaction to increase the activity of this reaction. However, these precious metal-based materials are expensive, which limits scale up. Additionally, recently, carbon-based materials have been used as catalysts for oxygen reduction reaction. Carbon-based catalysts have the advantage of less side reactions than metal-based catalysts, which exhibit a reaction that decomposes hydrogen peroxide, and these carbon-based catalysts show high cycle characteristics. In addition, these catalysts are inexpensive compared to non-precious metal-based materials, and thus are advantageous for mass production. However, since carbon-based materials themselves have low catalytic activity, they may be doped with heteroatoms, such as boron, nitrogen, oxygen, fluorine, phosphorus, and sulfur, to increase their catalytic activity.

The heteroatom that that has been most studied recently is oxygen. Doping with oxygen has the advantage of being able to easily increase the selectivity to hydrogen peroxide, but doping with oxygen has the disadvantage of greatly reducing the current value by greatly reducing the catalytic activity due to a decrease in the electrical conductivity of the material itself (Young Jin Sa et al., Angew. Chemie Int. Ed., 2019, 58, 1100-1105). Boron has been discussed as a heteroatom that can increase the selectivity to hydrogen peroxide without lowering catalytic activity (Yang Xia et al., Nat. Commun., 2021, 12, 4225). However, despite this high possibility, there are not many reports on various attempts to increase the two-electron activity of boron-doped carbon. That is, there are not many reports on the amount of boron, the boron-carbon arrangement structure, and a specific boron active site. In addition, for reported boron-doped carbon materials, the maximum value of boron doping is 0.91 at. %, which indicates the difficulty of doping with a large amount of boron (Yang Xia et al., Nat. Commun., 2021, 12, 4225).

Accordingly, the present inventors have made extensive efforts to solve the above-described problems, and as a result, have found that, when a porous carbon material is synthesized from carbon dioxide-containing gas using a reducing agent, the porous carbon material may be doped with a large amount of boron (up to 16 at. %), and the produced carbon material has porosity due to CO gas generated by activation of the carbon dioxide gas at high temperature and thus may be used as a catalyst for two-electron oxygen reduction reaction, thereby completing the present invention.

### SUMMARY OF THE INVENTION

An object of the present invention is to provide a method for electrochemical production of hydrogen peroxide using a boron-containing porous carbon material obtained from carbon dioxide-containing gas.

To achieve the above object, the present invention provides a method for electrochemical production of hydrogen peroxide, the method including producing H₂O₂ from O₂ using a boron-doped carbon material produced through a step of adding a boron-containing reducing agent to a carbon dioxide-containing gas to form a mixture and reacting the mixture at a temperature of 500 to 1,000° C. to obtain a boron-doped porous carbon material having micropores (<2 nm) and mesopores (2 to 50 nm).

The present invention also provides a catalyst for electrochemical production of hydrogen peroxide, wherein the catalyst is produced by a production method including steps of adding a boron-containing reducing agent to a carbon dioxide-containing gas to form a mixture, reacting the mixture at a temperature of 500 to 1,000° C. to obtain a boron-doped porous carbon material having micropores (<2 nm) and mesopores (2 to 50 nm), and then impregnating the boron-doped porous carbon material with a boron activator, followed by heat treatment under inert gas conditions.

### Effects of the Invention

The method of synthesizing a hierarchical porous carbon material using carbon dioxide as a raw material according to the present invention is not a high-temperature/high-pressure supercritical process of producing a carbon material using carbon dioxide as a raw material according to a conventional art, but is an environmentally friendly process of synthesizing a carbon material from carbon dioxide under mild conditions at normal pressure, and is an economical process that can reduce energy consumption compared to a conventional production process.

In addition, the hierarchical porous carbon material synthesized using carbon dioxide according to the present invention has micropores and mesopores, which are hierarchically present, and it may be used as a catalyst for a two-electron oxygen reduction reaction (ORR), which occurs at the cathode of a fuel cell, due to the doped heteroatom boron, and has the potential to replace expensive palladium catalysts.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart showing steps of producing a hierarchical porous carbon material according to Example 1 of the present invention;

FIG. 2 is a flowchart showing steps of producing a hierarchical porous carbon material according to Example 2 of the present invention;

FIG. 3 is a flowchart showing steps of producing a hierarchical porous carbon material according to Example 3 of the present invention;

FIG. 4 is a flowchart showing steps of producing a hierarchical porous carbon material according to Example 4 of the present invention;

FIG. 5 shows the adsorption and desorption isotherms (a) and BET surface areas (b) of the hierarchical porous carbon materials according to Examples 1 to 4 of the present invention;

FIG. 6 shows the BJH desorption pore distribution of each of the hierarchical porous carbon materials according to Examples 1 to 4 of the present invention;

FIG. 7 shows the amounts of boron (at %) obtained from XPS according to Examples 1 to 4 of the present invention;

FIG. 8 relates to the boron-carbon arrangement structures obtained from XPS according to Examples 1 to 3 of the present invention;

FIG. 9 relates to boron-carbon arrangement structures depending on the template/reducing agent ratio, obtained from XPS according to Example 4 of the present invention.

FIG. 10 shows the current potential curve (a) obtained by linear cyclic voltammetry (LSV) using each of the hierarchical porous carbon materials according to Examples 1 to 4 of the present invention as an electrode, and hydrogen peroxide selectivity (b) in oxygen reduction reaction.

FIG. 11 shows I-V graph results obtained in flow cells using each of the porous carbon materials according to Examples 1 to 3 of the present invention as an electrode.

FIG. 12 shows the results obtained in flow cells using, as an electrode, each of porous carbon materials produced using different ratios of templates and a reducing agent according to Example 4 of the present invention.

FIG. 13 shows the amount of hydrogen peroxide electrochemically produced in a flow cell using, as an electrode, the porous carbon material produced according to Example 3 of the present invention.

FIG. 14 shows the absorbance of UV-visible spectroscopy depending on the amount of hydrogen peroxide used and the absorbance at 319 nm depending on the Ce⁴⁺ concentration, measured using the Ce(SO₄)₂ titration method based on the results shown in FIG. 13.

### DETAILED DESCRIPTION OF THE INVENTION

Unless otherwise defined, all technical and scientific terms used in the present specification have the same meanings as commonly understood by those skilled in the art to which the present invention pertains. In general, the nomenclature used in the present specification is well known and commonly used in the art.

In the present invention, it has been found that, when a boron-containing reducing agent alone is added to a carbon dioxide-containing gas or when a carbon dioxide-containing gas is allowed to flow on a carbon dioxide-containing gas mixed with nanotemplates, it is possible to produce a hierarchical porous carbon material having a uniform pore distribution and containing micropores (<2 nm) and mesopores (2 to 50 nm), and the carbon material exhibits excellent performance as an electrochemical material, such as a catalyst for two-electron oxygen reduction reaction.

Therefore, in one aspect, the present invention is directed to a method for electrochemical production of hydrogen peroxide, the method including producing H₂O₂ from O₂ using a boron-doped carbon material produced through a step of adding a boron-containing reducing agent to a carbon dioxide-containing gas to form a mixture and reacting the mixture at a temperature of 500 to 1,000° C. to obtain a boron-doped porous carbon material having micropores (<2 nm) and mesopores (2 to 50 nm).

In the present invention, nanotemplates may be additionally added to the carbon dioxide-containing gas.

In the present invention, the method of producing the boron-doped carbon material may further include, after the reduction reaction, a step of (i) heat-treating the boron-doped porous carbon material under an inert gas atmosphere, or (ii) impregnating the boron-doped porous carbon material with a boron-containing reducing agent, followed by heat treatment under an inert gas atmosphere.

Hereinafter, the process of the present invention will be described in detail.

The method for producing a porous carbon material according to the present invention may include a step of reacting a carbon dioxide-containing gas with a reducing agent (hereinafter referred to as “one-step production process”).

The method of producing a hierarchical porous carbon material according to the present invention may include steps of mixing a reducing agent with nanotemplates having a size of several nm to several hundred nm and reacting a carbon dioxide-containing gas with the mixture (hereinafter referred to as “two-step production process”).

In addition, the method of producing a porous carbon material according to the present invention may include, after the one-step production process, a step of heat-treating the boron-doped porous carbon material under inert gas conditions (hereinafter referred to as “continuous production process”).

In addition, the method of producing a porous carbon material according to the present invention may include, after the one-step production process or the second-step production process, a step of impregnating the boron-doped porous carbon material with a boron precursor, followed by heat treatment under inert gas conditions (hereinafter referred to as “continuous production process”).

The boron-containing reducing agent that is used in the present invention may be boron oxide (B₂O₃), boric acid (H₂BO₃), or borohydride.

As the borohydride, alkali metal or alkaline earth metal borohydrides may be used alone or in combination of two or more thereof. Specifically, the borohydride may be lithium borohydride (LiBH₄), sodium borohydride (NaBH₄), potassium borohydride (KBH₄), magnesium borohydride (Mg(BH₄)₂), calcium borohydride (Ca(BH₄)₂), or strontium borohydride (Sr(BH₄)₂). In addition, the boron-containing reducing agent may be sodium tetraborate (Na₂B₄O₅(OH)₄·8H₂O) or barium tetraborate (BaB₂O₄), without being limited thereto.

In the present invention, the reduction reaction using the boron-containing reducing agent may be performed at an absolute pressure of 0.01 to 100 atm, preferably 0.05 to 50 atm.

In the reduction reaction, the carbon dioxide-containing gas may be pure carbon dioxide, or carbon dioxide-containing flue gas or production process waste gas, and the carbon dioxide content in the gas may be 1 to 100 moles.

The reduction reaction may be performed at 300° C. or higher, preferably 400° C. or higher, more preferably 400 to 1,000° C., most preferably 500 to 700° C. A temperature of 500° C. or higher is required to completely convert carbon dioxide into activated carbon. In order to increase electrochemical performance, the temperature in the reduction reaction may be increased to 700° C. or higher, thereby increasing the specific surface area characteristics.

In the reduction reaction, the temperature may be increased at a rate of 1 to 30° C./min, preferably 1 to 10° C./min.

The nanotemplates that are used in the reduction reaction may be composed of a transition metal, an alkali metal, an alkaline earth metal, or a precious metal, or an oxide (MetalₓO_{y}), carbonate (Metalₓ(CO₃)_{y}) or chloride thereof. Here, the transition metal may be nickel (Ni), cobalt (Co), copper (Cu), zinc (Zn), titanium (Ti), iron (Fe), or manganese (Mn), the alkali metal may be lithium (Li), sodium (Na), or cesium (Cs), the alkaline earth metal may be magnesium (Mg), calcium (Ca), or strontium (Sr), and the precious metal may be gold (Au), platinum (Pt), or silver (Ag). In addition, these compounds may be used alone or in combination of two or more thereof.

Specific examples of the metal oxide include CaO, MgO, Fe₂O₃, and Fe₃O₄, and specific examples of the metal carbonate include CaCO₃, Na₂CO₃, NiCO₃, COCO₃, Li₂CO₃, and FeCO₃. However, the metal oxide or the metal carbonate is not limited to these examples, and any type of material including the metal mentioned above may be used.

In the present invention, mixing of the reducing agent and the nanotemplates may be performed by either physical mixing or liquid mixing using one selected from the group consisting of cold water and alcohol.

In the present invention, after the hierarchical porous carbon material is produced through the one-step production process, the continuous production process, or the two-step production process, it may be washed with an acid, hot water, cold water, or an alcohol to remove the nanotemplates and then dried. Specifically, hydrochloric acid, sulfuric acid, etc. may be used as the acid, and methanol, ethanol, etc. may be used as the alcohol. In this case, the purity of the acid or alcohol may be 1 to 100 mol %, and the temperature may be 0 to 100° C.

The step of drying the hierarchical porous carbon material washed by the above process is performed at 50 to 150° C., preferably 90 to 120° C., at an absolute pressure of 0 to 1 atm, until the liquid is completely removed.

The heat treatment step may be performed at 500° C. or higher, preferably 500 to 900° C., more preferably 600 to 900° C., most preferably 700 to 900° C. In the heat treatment step, the temperature may be increased at a rate of 1 to 30° C./min, preferably 1 to 10° C./min. In the heat treatment step, after the temperature is increased, the increased temperature may be maintained for 10 minutes to 10 hours, preferably 1 hour to 10 hours, most preferably 2 to 3 hours.

The amount of the boron-containing reducing agent used may be 1 to 300 wt % based on the produced hierarchical porous carbon material, and the degree of metal loading of the final product may be determined depending on the amount of the boron-containing reducing agent used.

In addition, in the present invention, the method of producing the boron-doped carbon material may include, before the heat-treatment step, a step of impregnating the boron-doped porous carbon material with a boron activator (boron precursor). In this case, the boron activator may be at least one selected from the group consisting of boron oxide (B₂O₃), boric acid (H₂BO₃), lithium borohydride (LiBH₄), sodium borohydride (NaBH₄), potassium borohydride (KBH₄), magnesium borohydride (Mg(BH₄)₂), calcium borohydride (Ca(BH₄)₂), strontium borohydride (Sr(BH₄)₂), sodium tetraborate (Na₂B₄O₅(OH)₄·8H₂O), and barium tetraborate (BaB₂O₄).

In the present invention, it has been found that a hierarchical porous carbon material containing boron may be produced by a method including steps of adding a boron-containing reducing agent to a carbon dioxide-containing gas to form a mixture, reacting the mixture at a temperature of 500 to 1,000° C. to obtain a boron-doped porous carbon material having micropores (<2 nm) and mesopores (2 to 50 nm), and then impregnating the boron-doped porous carbon material with a boron activator, followed by heat treatment under inert gas conditions, and that the hierarchical porous carbon material may be used as a catalyst for two-electron oxygen reduction reaction (ORR) for the electrochemical production of hydrogen peroxide due to the hierarchical presence of micropores and mesopores.

Therefore, another aspect of the present invention is directed to a catalyst for electrochemical production of hydrogen peroxide, wherein the catalyst is produced by a production method including steps of adding a boron-containing reducing agent to a carbon dioxide-containing gas to form a mixture, reacting the mixture at a temperature of 500 to 1,000° C. to obtain a boron-doped porous carbon material having micropores (<2 nm) and mesopores (2 to 50 nm), and then impregnating the boron-doped porous carbon material with a boron activator, followed by heat treatment under inert gas conditions.

The catalyst for electrochemical production of hydrogen peroxide according to the present invention may have a BET surface area of 200 to 1,200 m²/g, a pore volume of 0.37 to 3.00 cm³/g, a mesopore volume of 0.35 to 2.00 cm³/g, an Ip/IG value of 0.7 to 1.2, as determined by Raman analysis, and a Tafel slope value of 50 to 100 mV/dec.

In the boron composition of the carbon material, the proportion of BC₃, BC₂O and BCO₂ may increase. Specifically, the proportion of BC₃ may be 10 to 30 at. %, the proportion of BC₂O may be 10 to 20 at. %, and the proportion of BCO₂ is 10 to 30 at. %. It can be, in this case, at. % is an abbreviation for atomic percent and means the composition ratio of the number of atoms.

In this case, at. % is an abbreviation for atomic percent and means the percentage of the number of atoms.

Here, synthesis may be performed until the amount of doped boron becomes up to 16 at %, and thus a carbon material doped with a large amount of boron may be obtained. In addition, the produced carbon material has an advantage in that it is possible to synthesize a porous carbon material due to a CO gas generated by activation of carbon dioxide gas at high temperature.

The reaction formula therefor is as follows:

CO₂+C→2CO

In addition, there is an advantage in that it can bring about a carbon dioxide reduction effect by utilizing carbon dioxide and carbon dioxide-containing flue gas and production process waste gas.

When the carbon material is used as a catalyst for oxygen reduction reaction, the mass activity thereof for two-electron oxygen reduction reaction in 0.1M KOH solution may be 50 A/g or more.

In addition, when the carbon material is used as a catalyst for oxygen reduction reaction, the onset potential thereof for two-electron oxygen reduction reaction in 0.1M KOH solution may be 0.6 to 0.9 V.

In addition, when the carbon material is used as a catalyst for oxygen reduction reaction, the selectivity thereof for two-electron oxygen reduction reaction may be 70 to 100%, and the amount of electrochemically produced hydrogen peroxide may be 1 to 50 mol g_{cat}⁻¹ h⁻¹.

Hereinafter, preferred examples will be presented to aid understanding of the present invention. However, the following examples are merely illustrative of the present invention, and it will be obvious to those skilled in the art that various changes and modifications are possible within the scope and spirit of the present invention. Naturally, such changes and modifications fall within the scope of the appended claims.

### EXAMPLES

### Example 1: Production of Porous Carbon Material by One-Step Production Process

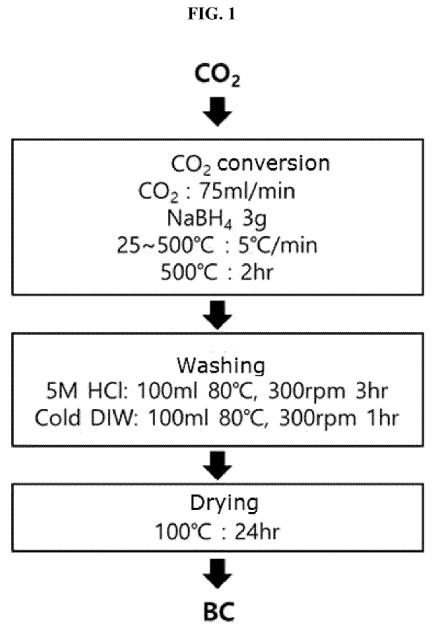

A porous carbon material was produced from carbon dioxide using a reducing agent according to the procedure shown in FIG. 1.

3 g of sodium borohydride (NaBH₄, >96%, Sigma-Aldrich) was placed in an alumina crucible which was then placed in a furnace. The furnace was purged for 30 minutes while carbon dioxide (CO₂, >99.99%, Samo Gas, Korea) was flowed at a flow rate of 75 ml/min. Thereafter, the temperature of the furnace was increased from 25° C. to 500° C. at a rate of 5° C./min and maintained at 500° C. for 2 hours. After the furnace cooled down, the resulting porous carbon material was washed with 5M hydrochloric acid, hot water, cold water, and ethanol to remove the salt.

For initial washing with cold water, the carbon material was added to 100 ml of distilled water in a 250 ml beaker, and stirred at 300 rpm for 30 minutes at room temperature, and then the washed material was filtered through 1 μm filter paper. Subsequently, for washing with hydrochloric acid, the carbon material was added to 100 ml of 5M hydrochloric acid in a 250 ml beaker, and stirred at 300 rpm for 1 hour at 80° C., and then the washed material was filtered through 1 μm filter paper. Subsequently, for washing with cold water, the carbon material was added to 100 ml of distilled water in a 250 ml beaker, and stirred at 300 rpm for 1 hour at room temperature, and then the washed material was filtered through 1 μm filter paper. Finally, for washing with ethanol, the carbon material was added to 100 ml of ethanol (>99%, Daejeong, Korea) in a 250 ml beaker, and stirred at 300 rpm for 30 minutes at room temperature, and then the washed material was filtered through 1 μm filter paper.

The precipitate from which the salt has been removed through the above-described washing process was dried in an oven at 100° C. and an absolute pressure of 1 atm for one day. Through the above-described process, a porous carbon material was synthesized from carbon dioxide. The carbon material synthesized in Example 1 is marked BC in FIG. 1.

### Example 2: Production of Porous Carbon Material According to CO₂ Activation

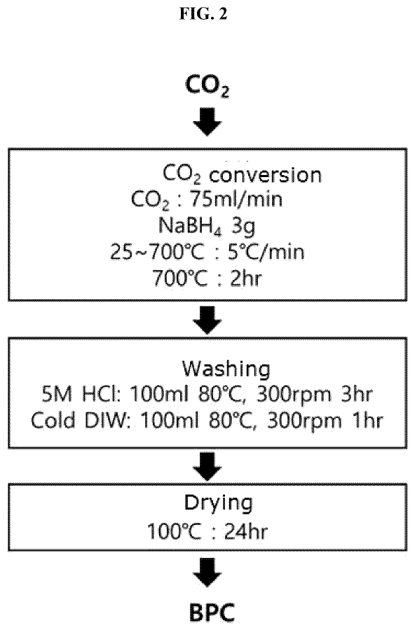

A porous carbon material was produced from carbon dioxide using a reducing agent according to the procedure shown in FIG. 2.

3 g of sodium borohydride (NaBH₄, >96%, Sigma-Aldrich) was placed in an alumina crucible which was then placed in a furnace. The furnace was purged for 30 minutes while carbon dioxide (CO₂, >99.99%, Samo Gas, Korea) was flowed at a flow rate of 75 ml/min. Thereafter, the temperature of the furnace was increased from 25° C. to 700° C. at a rate of 5° C./min and maintained at 700° C. for 2 hours. After the furnace cooled down, the resulting porous carbon material was washed with 5M hydrochloric acid, hot water, cold water, and ethanol to remove the salt.

For initial washing with cold water, the carbon material was added to 100 ml of distilled water in a 250 ml beaker, and stirred at 300 rpm for 30 minutes at room temperature, and then the washed material was filtered through 1 μm filter paper. Subsequently, for washing with hydrochloric acid, the carbon material was added to 100 ml of 5M hydrochloric acid in a 250 ml beaker, and stirred at 300 rpm for 1 hour at 80° C., and then the washed material was filtered through 1 μm filter paper. Subsequently, for washing with cold water, the carbon material was added to 100 ml of distilled water in a 250 ml beaker, and stirred at 300 rpm for 1 hour at room temperature, and then the washed material was filtered through 1 μm filter paper. Finally, for washing with ethanol, the carbon material was added to 100 ml of ethanol (>99%, Daejeong, Korea) in a 250 ml beaker, stirred at 300 rpm for 30 minutes at room temperature, and then the washed material was filtered through 1 μm filter paper.

The precipitate from which the salt has been removed through the above-described washing process was dried in an oven at 100° C. and an absolute pressure of 1 atm for one day. Through the above-described process, a porous carbon material was synthesized from carbon dioxide. The carbon material synthesized in Example 2 is marked BPC in FIG. 2.

### Example 3: Production of Porous Carbon Material According to CO₂ Activation and Impregnation with Boron

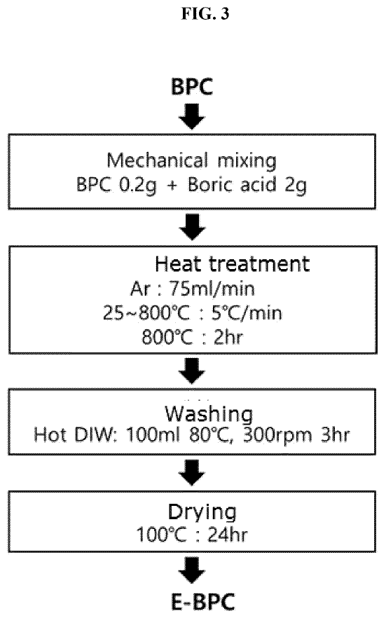

A carbon material with an increased boron content was produced using a boron precursor according to the method described in Example 2. 0.2 g of the carbon material produced in Example 2 was physically mixed with 2 g of boric acid (H₃BO₃, >99.5%, Samchun) among the boron precursors listed above. Thereafter, the mixture was placed in an alumina crucible which was then placed in a furnace, and argon gas (Ar, >99.999%, tri-oxygen gas) was flowed at a rate of 50 ml/min. Next, the temperature of the furnace was increased from 25° C. to 800° C. at a rate of 5° C./min and maintained at 800° C. for 2 hours. Next, for washing with hot water, the resulting carbon material was added to 100 ml of distilled water in a 250 ml beaker, and stirred at 300 rpm for 30 minutes at 80° C., and then the washed material was filtered through 1 μm filter paper. Finally, for washing with ethanol, the carbon material was added to 100 ml of ethanol (>99%, Daejeong, Korea) in a 250 ml beaker, and stirred at 300 rpm for 30 minutes at room temperature, and then the washed material was filtered through 1 μm filter paper. The precipitate from which the nanotemplates and salt have been removed through the above-described washing process was dried in an oven at 100° C. and an absolute pressure of 1 atm for one day. Through the above-described process, a boron-reinforced porous carbon material was synthesized from carbon dioxide. The carbon material synthesized in Example 3 is marked E-BPC in FIG. 3.

### Example 4: Production of Porous Carbon Material According to Two-Step Production Process

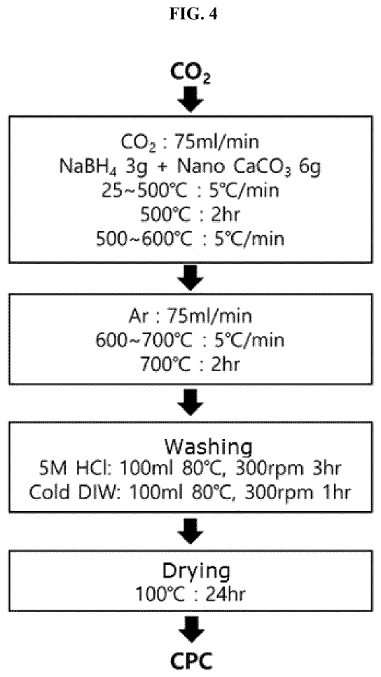

A hierarchical porous carbon material was produced from carbon dioxide using borohydride and calcium carbonate (CaCO₃) nanotemplates according to the procedure shown in FIG. 4.

3 g of sodium borohydride (NaBH₄, >96%, Sigma-Aldrich) was physically mixed with 6 g of calcium carbonate (CaCO₃) nanotemplates (15 to 40 nm) for 30 minutes. Thereafter, the mixture was placed in an alumina crucible which was then placed in a furnace. The furnace was purged for 30 minutes while carbon dioxide (CO₂, >99.99%, Samo Gas, Korea) was flowed at a flow rate of 75 ml/min. Thereafter, the temperature of the furnace was increased from 25° C. to 700° C. at a rate of 5° C./min and maintained at 700° C. for 2 hours. Next, the temperature of the furnace was increased to 600° C. at a rate of 5° C./min under carbon dioxide, and then the carbon dioxide gas was turned off, and argon gas (Ar, >99.999%, Samo Gas, Korea) was flowed at a rate of 50 ml/min. Thereafter, the temperature was increased to 700° C. at a rate of ° C./min and maintained at 700° C. for 2 hours. After the furnace cooled down, the resulting hierarchical porous carbon material was washed with 5M hydrochloric acid, hot water, cold water, and ethanol to remove the nanotemplates and salt.

For initial washing with hydrochloric acid (twice), the carbon material was added to 100 ml of 5M hydrochloric acid in a 250 ml beaker, and stirred at 300 rpm for 1 hour at 80° C., and then the washed material was filtered through 1 μm filter paper. Subsequently, for washing with hot water (twice), the carbon material was added to 100 ml of distilled water in a 250 ml beaker, and stirred at 300 rpm for 1 hour at 80° C., and then the washed material was filtered through 1 μm filter paper. Subsequently, for washing with cold water, the carbon material was added to 100 ml of distilled water in a 250 ml beaker, and stirred at 300 rpm for 30 minutes at room temperature, and then the washed material was filtered through 1 μm filter paper. Finally, for washing with ethanol, the carbon material was added to 100 ml of ethanol (>99%, Daejeong, Korea) in a 250 ml beaker, and stirred at 300 rpm for 30 minutes at room temperature, and then the washed material was filtered through 1 μm filter paper.

The precipitate from which the nanotemplates and salt have been removed through the above-described washing process was dried in an oven at 100° C. and an absolute pressure of 1 atm for one day. Through the above-described process, a hierarchical porous carbon material was synthesized from carbon dioxide. The carbon material synthesized in Example 4 is marked CPC in FIG. 4.

### Experimental Example 1: Comparison of Adsorption Isotherms, Micropore Distributions and Mesopore Distributions of Hierarchical Porous Carbon Materials

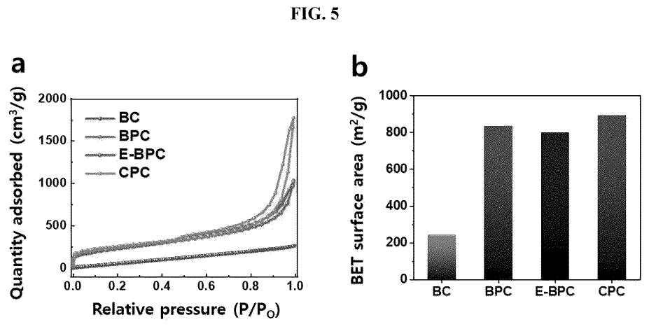

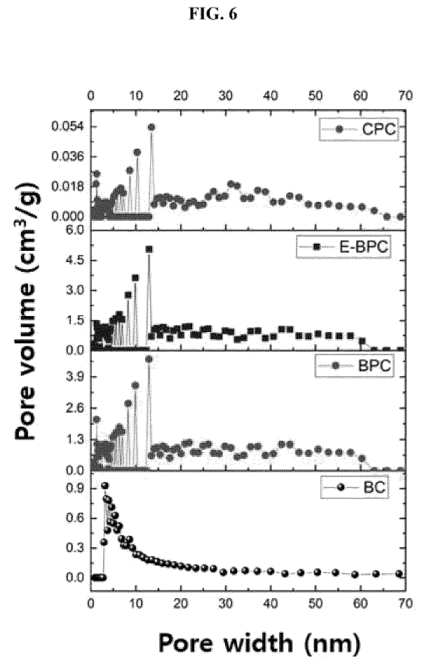

FIGS. 5 and 6 respectively show the adsorption/desorption isotherms (a), BET surface areas (b), and Barrett-Hoyner-Halenda (BJH) mesopore distributions of the hierarchical porous carbon materials produced in Examples 1, 2, 3 and 4.

As a result, it could be found that the BET surface areas of the hierarchical porous carbon materials produced in Examples 1, 2, 3 and 4 were 244.8 m²/g, 834.6 m²/g, 799.8 m²/g, and 894.4 m²/g, respectively. In addition, the pore distribution of each carbon material was analyzed according to the BJH method, and as a result, it could be found that the produced porous carbon materials had a hierarchical pore structure. In particular, the carbon material synthesized in Example 4 had a higher pore volume at 20 to 40 nm compared to the other carbon materials, and this is because mesopores of several tens of nm were developed using nanotemplates.

### Experimental Example 2: Comparison of Differences in Amount of Doped Boron and Boron-Carbon Arrangement Structure Between Hierarchical Porous Carbon Materials

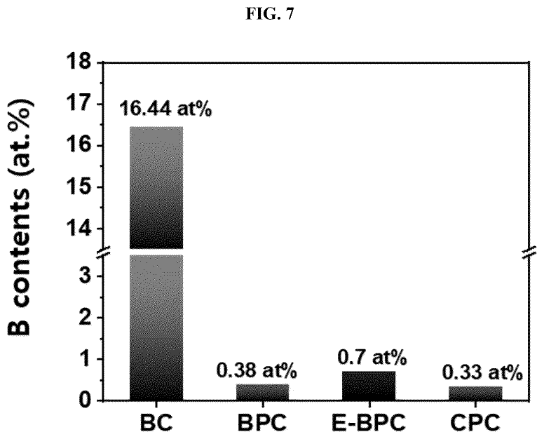

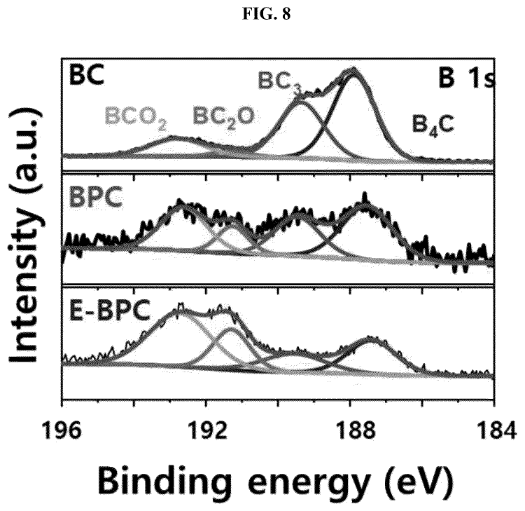

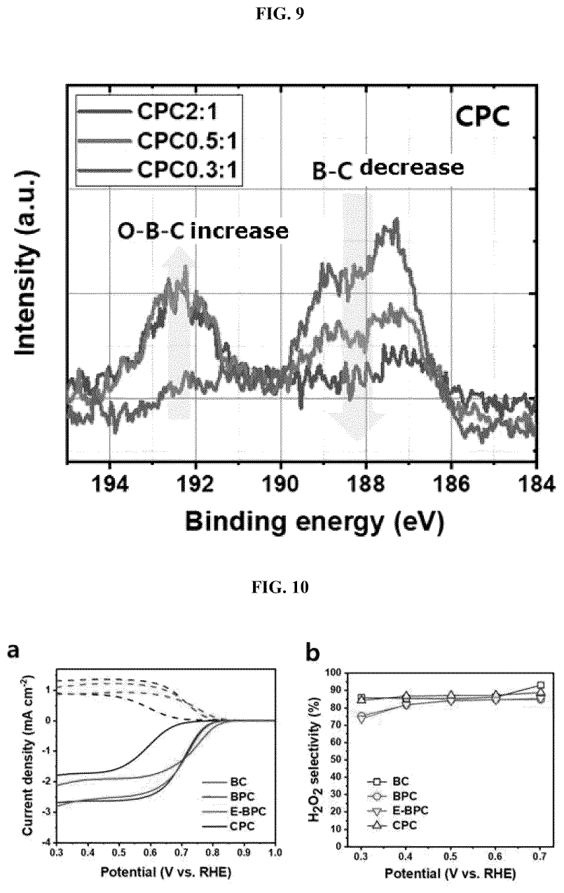

The amount of boron contained in each of the hierarchical porous carbon materials produced in Examples 1 to 4 was analyzed through X-ray Photoelectron Spectroscopy (XPS), and the results are shown in FIG. 7. The amounts of boron in the porous carbon materials obtained in Examples 1 to 4 were 16.44, 0.38, 0.7, and 0.33 at %, respectively. FIG. 8 shows the results of deconvolution of the XPS Bls peak for the boron-carbon arrangement structures of the porous carbon materials obtained in Examples 1 to 3. FIG. 9 shows the results of deconvolution of the XPS BIs peak for the boron-carbon arrangement structure of the porous carbon material obtained in Examples 4. As shown in FIG. 8, it was found that, in the case of the carbon material obtained in Example 1, that is, the carbon material obtained by converting CO₂ to carbon by the reducing agent without the effect of CO₂ activation, B₄C, BC₃, BC₂O, and BCO₂ accounted for 50.1%, 33.8%, 2.8%, and 13.3%, respectively. As shown in FIG. 8, it was found that, in the case of the carbon obtained in Example 2, that is, the carbon material obtained by converting CO₂ to carbon by the reducing agent with the effect of CO₂ activation, B₄C, BC₃, BC₂O, and BCO₂ accounted for 37.4%, 24.3%, 11.2%, and 27.1%, respectively (Table 1). As shown in FIG. 8, it was found that, in the case of the carbon obtained in Example 3, that is, the carbon material obtained by converting CO₂ to carbon by the reducing agent with the effect of CO₂ activation and impregnating the carbon material with boron as post-treatment, B₄C, BC₃, BC₂O, and BCO₂ accounted for 21.7%, 15.4%, 19.7%, and 43.2%, respectively. It can be seen that, going from Example 1 to 3, the proportion of B₄C decreased and the sum of the proportions of BC₃, BC₂O, and BCO₂ increased, indicating that B₄C has poor electrochemical performance and the remaining three bonds (BC₃, BC₂O, and BCO₂) have excellent electrochemical performance.

TABLE 1
Proportions of B₄C, BC₃,
BC₂O and BCO₂ in BC, BPC and E-BPC

| (at. %) | B₄C | BC | BC₂O | BCO₂ |
|---|---|---|---|---|
| BC | 51.14 | 33.81 | 2.79 | 13.26 |
| BPC | 37.42 | 24.26 | 11.21 | 27.11 |
| E-BPC | 21.72 | 15.35 | 19.69 | 43.24 |

FIG. 9 shows the change in B—C bond depending on the amount of nanotemplates added. The ratios of 2:1, 0.5:1, and 0.3:1 represent the relative mass ratios between the CaCO₃ nanotemplates and the reducing agent. It can be seen that, as the ratio of the nanotemplates increased, the B—C bond, which has a relatively low electrochemical activity, decreased, and the O—B—C bond increased.

### Experimental Example 3: Comparison of Current Potential Curves of Hierarchical Porous Carbon Materials by Linear Cyclic Voltammetry (LSV)

FIG. 10 shows the current potential curves of the hierarchical porous carbon materials, produced in Examples 1 to 4, by linear cyclic voltammetry (LSV). Linear cyclic voltammetry is a method of obtaining corresponding current data while changing the voltage at a constant rate within a specific range, and was performed while a glassy carbon electrode loaded with the catalyst was rotated at a speed of 1,600 rpm. In the case of two-electron oxygen reduction reaction, the higher the current density value, the higher the catalyst activity. In addition, the selectivity to hydrogen peroxide, that is, the selectivity to the two-electron reaction in the two-electron reaction that produces hydrogen peroxide and the four-electron reaction that produces water, may be expressed the ratio of the disk current to the ring current and calculated by the following equation:

H₂O₂ Selectivity=200*(Iᵣ/N)/(I_{d}+(Iᵣ/N)), N=0.25

In FIG. 10(a), it can be seen that the catalyst BC synthesized in Example 1 had a high boron content, but showed a low disk current, indicating that its activity as a catalyst is low due to its small surface area, and the catalyst BPC synthesized in Example 2 had an increased surface area due to CO₂ activation, which greatly increased the activity as a catalyst, resulting in a significant increase in the disk current. It can be seen that, in the case of the catalyst E-BPC synthesized in Example 3, the active sites increased due to the increased boron content, and the disk current increased due to the large surface area. Although the catalyst CPC synthesized in Example 4 had a low boron content, it had the highest surface area (894.4 m²/g) among the catalysts synthesized in Examples 1 to 4 and showed the highest disk current because it had a structure with developed mesopores of 20 to 40 nm. FIG. 10(b) is a graph showing the hydrogen peroxide selectivity calculated based on the measurement results shown in FIG. 10(a). Regarding selectivity to hydrogen peroxide, the catalysts synthesized in Examples 1, 2, 3 and 4 showed high selectivities of 85.1, 84.3, 87.1, and 84.0%, respectively, at a potential of 0.5V vs. RHE. In particular, although the catalysts synthesized in Examples 2 and 3 had similar specific surface areas, the catalyst synthesized in Example 3 had a higher selectivity, showing that boron acted as active sites of the catalyst.

### Experimental Example 4: Comparison of Current Potential Curves of Hierarchical Porous Carbon Materials by Flow Cell

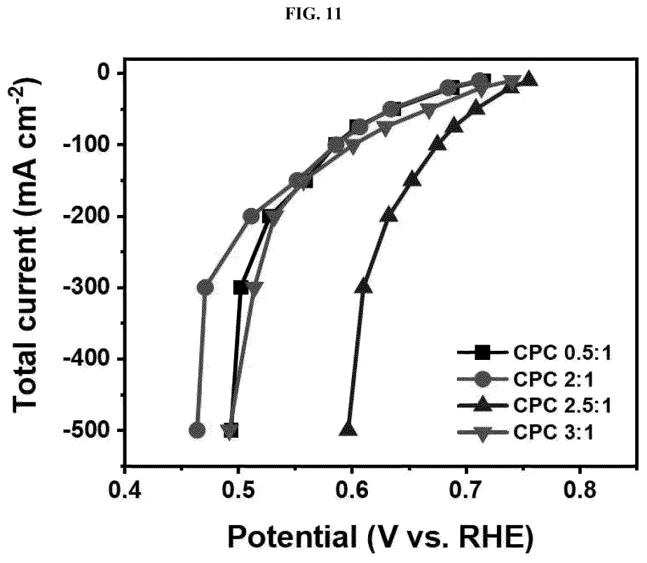

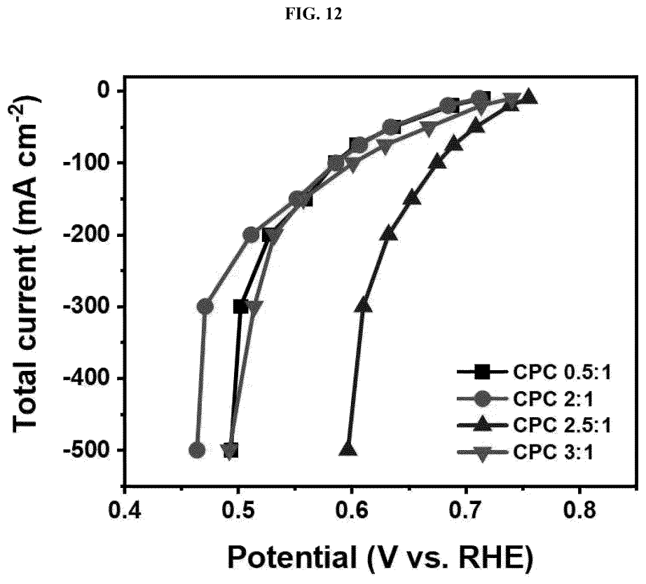

An electrode was fabricated by applying the catalyst E-BPC synthesized in Example 3 to a gas diffusion layer (GDL, Sigracet 39 BB) in an amount of 0.5 mg/cm⁻² through spray coating. An Hg/HgO electrode and a NiFeMo foil were used as a reference electrode and a counter electrode (anode), respectively, and FAA-3-PEEK (Fumatech) was used as a separator. 40 mL of 1M KOH solution was used as an electrolyte, and 20 sccm of oxygen was flowed, thereby constructing a flow cell. I-V curves were obtained by chronopotentiometry with 100% IR correction at various current densities. FIG. 11 shows the I-V curves of the porous carbon materials synthesized in Examples 1 to 3, and FIG. 12 shows the I-V curves of the porous carbon materials synthesized in Example 4. It was found that the carbon material produced in Example 1, that is, BC, showed the highest overpotential among the carbon materials produced in Examples 1 to 3, and E-BPC showed the lowest overpotential, indicating that it showed the best catalytic activity even in the flow cell. As shown in FIG. 12, it can be seen that, in the case of the carbon materials produced in Example 4, the electrochemical performance significantly changed depending on the amount of nanotemplates used. Depending on the amount of nanotemplate, the overpotential was higher in the order of 2.5:1<0.5:1=3:1<2:1.

### Experimental Example 5: Quantitative Analysis of Hydrogen Peroxide Electrochemically Produced by Flow Cell with Hierarchical Porous Carbon Material

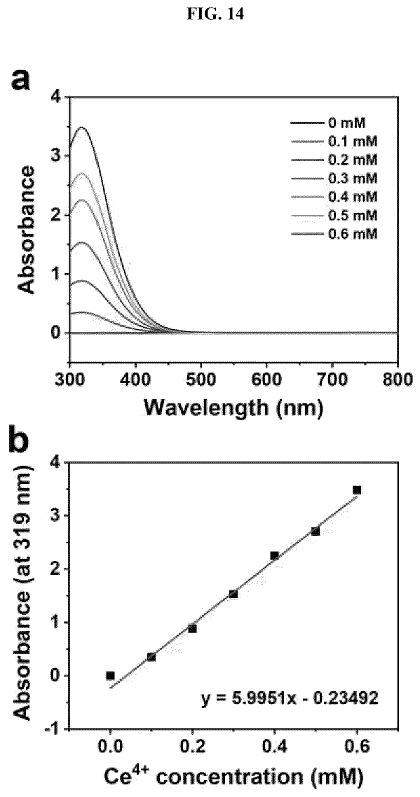

Hydrogen peroxide electrochemically produced by the flow cell was quantitatively analyzed using the Ce(SO₄)₂ titration method. The produced hydrogen peroxide reacted with Ce(SO₄)₂ according to the reaction formula below, and the amount of hydrogen peroxide was measured by UV-spectroscopy (Cary100, Varian). FIG. 14 shows the absorbance depending on the amount of hydrogen peroxide added and the absorbance at 319 nm depending on the Ce⁴ concentration.

H₂O₂+2Ce(SO₄)₂→Ce₂(SO₄)₃+H₂SO₄+O₂

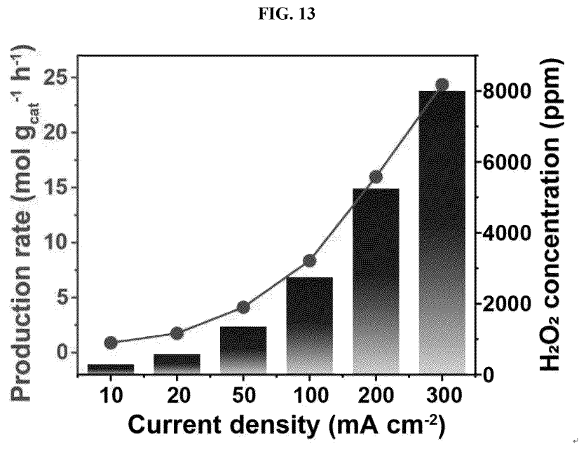

FIG. 13 shows the results of measuring, by titration, the amount of hydrogen peroxide produced when the porous carbon material produced in Example 3 was used as a catalyst for production of hydrogen peroxide. As shown in FIG. 13, it was found that 24.3 mol g_{cat}⁻¹ h⁻¹ of hydrogen peroxide per mass of the catalyst per hour was produced.

Although the present invention has been described in detail with reference to specific features, it will be apparent to those skilled in the art that this description is only of a preferred embodiment thereof, and does not limit the scope of the present invention. Thus, the substantial scope of the present invention will be defined by the appended claims and equivalents thereto.

1. A method for electrochemical production of hydrogen peroxide, the method comprising producing H₂O₂ from O₂ using a boron-doped carbon material,
wherein the boron-doped carbon material is produced by adding a boron-containing reducing agent to a carbon dioxide-containing gas to form a mixture and reacting the mixture at a temperature of 500 to 1,000° C. to obtain a boron-doped porous carbon material having micropores (<2 nm) and mesopores (2 to 50 nm).

2. The method for electrochemical production of hydrogen peroxide of claim 1, wherein nanotemplates are added to the carbon dioxide-containing gas.

3. The method for electrochemical production of hydrogen peroxide of claim 1, further comprising continuously heat-treating the boron-doped porous carbon material under inert gas conditions, after obtaining the boron-doped porous carbon material.

4. The method for electrochemical production of hydrogen peroxide of claim 1, wherein the boron-containing reducing agent is at least one selected from the group consisting of boron oxide (B₂O₃), boric acid (H₂BO₃), lithium borohydride (LiBH₄), sodium borohydride (NaBH₄), potassium borohydride (KBH₄), magnesium borohydride (Mg(BH₄)₂), calcium borohydride (Ca(BH₄)₂), strontium borohydride (Sr(BH₄)₂), sodium tetraborate (Na₂B₄O₅(OH)₄·8H₂O), and barium tetraborate (BaB₂O₄).

5. The method for electrochemical production of hydrogen peroxide of claim 2, wherein the nanotemplates are composed of a transition metal, an alkali metal, an alkaline earth metal, or a precious metal, or an oxide, carbonate or chloride thereof.

6. The method for electrochemical production of hydrogen peroxide of claim 5, wherein the transition metal is nickel (Ni), cobalt (Co), copper (Cu), zinc (Zn), titanium (Ti), iron (Fe), or manganese (Mn), the alkali metal is lithium (Li), sodium (Na), or cesium (Cs), the alkaline earth metal is magnesium (Mg), calcium (Ca), or strontium (Sr), and the precious metal is gold (Au), platinum (Pt), or silver (Ag).

7. The method for electrochemical production of hydrogen peroxide of claim 5, wherein the nanotemplates are composed of at least one selected from the group consisting of CaO, MgO, Fe₂O₃, Fe₃O₄, CaCO₃, Na₂CO₃, NiCO₃, COCO₃, Li₂CO₃, and FeCO₃.

8. The method for electrochemical production of hydrogen peroxide of claim 1, further comprising washing and drying the boron-doped porous carbon material under inert gas conditions, after obtaining the boron-doped porous carbon material.

9. The method for electrochemical production of hydrogen peroxide of claim 3, further comprising impregnating the boron-doped porous carbon material with a boron activator before the heat-treating.

10. The method for electrochemical production of hydrogen peroxide of claim 9, wherein the boron activator is at least one selected from the group consisting of boron oxide (B₂O₃), boric acid (H₂BO₃), lithium borohydride (LiBH₄), sodium borohydride (NaBH₄), potassium borohydride (KBH₄), magnesium borohydride (Mg(BH₄)₂), calcium borohydride (Ca(BH₄)₂), strontium borohydride (Sr(BH₄)₂), sodium tetraborate (Na₂B₄O₅(OH)₄·8H₂O), and barium tetraborate (BaB₂O₄).

11. A catalyst for electrochemical production of hydrogen peroxide,
wherein the catalyst is produced by a method comprising:
adding a boron-containing reducing agent to a carbon dioxide-containing gas to form a mixture, reacting the mixture at a temperature of 500 to 1,000° C. to obtain a boron-doped porous carbon material having micropores (<2 nm) and mesopores (2 to 50 nm), and
impregnating the boron-doped porous carbon material with a boron activator, followed by heat treatment under inert gas conditions.

12. The catalyst for electrochemical production of hydrogen peroxide of claim 11, wherein the catalyst has a BET surface area of 200 to 1,200 m²/g, a pore volume of 0.37 to 3.00 cm³/g, a mesopore volume of 0.35 to 2.00 cm³/g, an Ip/IG value of 0.7 to 1.2, as determined by Raman analysis, and a Tafel slope value of 50 to 100 mV/dec.

13. The catalyst for electrochemical production of hydrogen peroxide of claim 11, wherein a proportion of BC₃ in a boron composition is 10 to 30 at. %, a proportion of BC₂O is 10 to 20 at. %, and a proportion of BCO₂ is 10 to 30 at. %.

14. The method for electrochemical production of hydrogen peroxide of claim 2, further comprising continuously heat-treating the boron-doped porous carbon material under inert gas conditions, after obtaining the boron-doped porous carbon material.

15. The method for electrochemical production of hydrogen peroxide of claim 2, wherein the boron-containing reducing agent is at least one selected from the group consisting of boron oxide (B₂O₃), boric acid (H₂BO₃), lithium borohydride (LiBH₄), sodium borohydride (NaBH₄), potassium borohydride (KBH₄), magnesium borohydride (Mg(BH₄)₂), calcium borohydride (Ca(BH₄)₂), strontium borohydride (Sr(BH₄)₂), sodium tetraborate (Na₂B₄O₅(OH)₄·8H₂O), and barium tetraborate (BaB₂O₄).

16. The method for electrochemical production of hydrogen peroxide of claim 2, further comprising washing and drying the boron-doped porous carbon material under inert gas conditions, after obtaining the boron-doped porous carbon material.
